(19) United States
(12) Patent Application Publication
(10) Pub. No.: US 2011/0158630 A1
(43) Pub. Date: Jun. 30, 2011

(54) ELECTRONIC PHOTOGRAPHING APPARATUS

(75) Inventors: Toshifumi NAKANO, Sagamihara-shi (JP); Tsuyoshi FUKUTA, Tokyo (JP)

(73) Assignees: OLYMPUS CORPORATION, Tokyo (JP); OLYMPUS IMAGING CORP., Tokyo (JP)

(21) Appl. No.: 13/042,055

(22) Filed: Mar. 7, 2011

Related U.S. Application Data
(63) Continuation of application No. PCT/JP2009/063201, filed on Jul. 23, 2009.

(30) Foreign Application Priority Data
Sep. 5, 2008 (JP) 2008-228664

(51) Int. Cl. G03B 17/04; H04N 5/225; G03B 17/02

(52) U.S. Cl. 396/349; 348/376; 396/535; 348/E05.026

(57) ABSTRACT

In order to provide an electronic photographing apparatus capable of reduction in size and cost and obtaining a stable photographic image, the invention includes a structure having an electric circuit board and an electronic photographing apparatus constituting unit (barrel unit, strobe unit, display device unit, battery case, recording medium case) attached to the electric circuit board and a box-shaped exterior body in which the structure is inserted and housed.

### CROSS REFERENCE TO RELATED APPLICATION

This application is a continuation application of PCT/JP 2009/063201 filed on Jul. 23, 2009 and claims the benefit of Japanese Application No. 2008-228664 filed in Japan on Sep. 5, 2008, the entire contents of each of which are incorporated herein by their reference.

### BACKGROUND OF THE INVENTION

1. Field of the Invention

The present invention relates to an electronic photographing apparatus and more particularly to a structure for housing various kinds of components which constitute an electronic photographing apparatus.

2. Description of Related Art

Conventionally, as a structure for housing components of an electronic photographing apparatus such as a digital camera, a housing structure in which a lens barrel, an electric circuit board, a battery and the like are mounted on a camera main body and the camera main body is covered with an exterior cover has been generally employed.

FIG. 10 is an exploded perspective view of a digital camera, which shows one example of an electronic photographing apparatus employing the above-described conventional structure for housing the components. As shown in FIG. 10, the conventional digital camera 100 includes: a box-shaped main body 101, one face of which is open; a front exterior case 102; a rear exterior case 103; a lens barrel 104 for holding a taking lens; a strobe unit 105 including a strobe light-emitting portion; a main board unit 106 to which a recording medium case 107 is secured, a recording medium 108 being mounted/dismounted on/from the recording medium case 107; a display unit 109 having an LCD, which is mounted on an inner face of the rear exterior case 103; and a battery case unit 110 in which a battery 111 can be loaded detachably. The lens barrel 104, the strobe unit 105 and the main board unit 106 are secured to the main body 101 with screws, and the front exterior case 102 and the rear exterior case 103 are secured to the main body 101 so as to cover the front face and rear face of the main body 101, thereby the digital camera 100 is completed.

Note that a camera having the same structure as the above-described structure for housing the components is disclosed in Japanese Patent Application Laid-Open Publication No. 2008-20928, for example.

In recent years, size reduction of mobile electronic devices such as digital cameras and mobile phones has been developed while maintaining high functionality, and an idea of eliminating a part forming a framework of a main body by forming an exterior body with a reinforced member has been conceived, for example.

In a case of a photographing apparatus, when a lens barrel itself, which holds a taking lens, is distorted due to an external force applied to the lens barrel or temperature changes, the distortion of the lens barrel degrades a quality of a photographic image. Therefore, a lens barrel is usually attached to a member which is relatively resistant to an external force and temperature changes. Also in the structure for housing components of the conventional digital camera 100 shown in FIG. 10, the lens barrel 104 is secured to the box-shaped main body, thereby preventing degradation of a photographic image. However, since the box-shaped main body in addition to the exterior cover is required for completing the digital camera, such a configuration is disadvantageous for reduction in size and cost.

### SUMMARY OF THE INVENTION

An electronic photographing apparatus according to one aspect of the present invention includes: a structure including an electric circuit board and an electronic photographing apparatus constituting unit attached to the electric circuit board; and a box-shaped exterior body configured to house the structure.

### BRIEF DESCRIPTION OF THE DRAWINGS

FIG. 1 is an exploded perspective view of an electronic photographing apparatus (digital camera) according to a first embodiment of the present invention.

FIG. 2 is an exploded perspective view of an electronic photographing apparatus (digital camera) according to a second embodiment of the present invention.

FIG. 3 is an exploded perspective view of an electronic photographing apparatus (digital camera) according to a third embodiment of the present invention.

FIG. 4 is a vertical cross-sectional view of the electronic photographing apparatus (digital camera) shown in FIG. 3.

FIG. 5 is a vertical cross-sectional view along an optical axis illustrating the electronic photographing apparatus (digital camera) shown in FIG. 3 in a state where a camera structure is inserted in an exterior case.

FIG. 6 is a vertical cross-sectional view along an optical axis illustrating the electronic photographing apparatus (digital camera) shown in FIG. 3 in a state where the lens barrel is set in a collapsed position after the camera structure is inserted into the exterior case.

FIG. 7 is a vertical cross-sectional view of an electronic photographing apparatus (digital camera) along an optical axis according to a modified example of the third embodiment of the present invention to which a photographing optical system formed of a bending optical system is applied.

FIG. 8 is an exploded perspective view of an electronic photographing apparatus (digital camera) according to a fourth embodiment of the present invention.

FIG. 9 is an exploded perspective view of an electronic photographing apparatus (digital camera) according to a fifth embodiment of the present invention.

FIG. 10 is an exploded perspective view of a conventional electronic photographing apparatus (digital camera).

### DETAILED DESCRIPTION OF THE PREFERRED EMBODIMENTS

Hereinafter, the present invention will be described with reference to embodiments shown in figures.

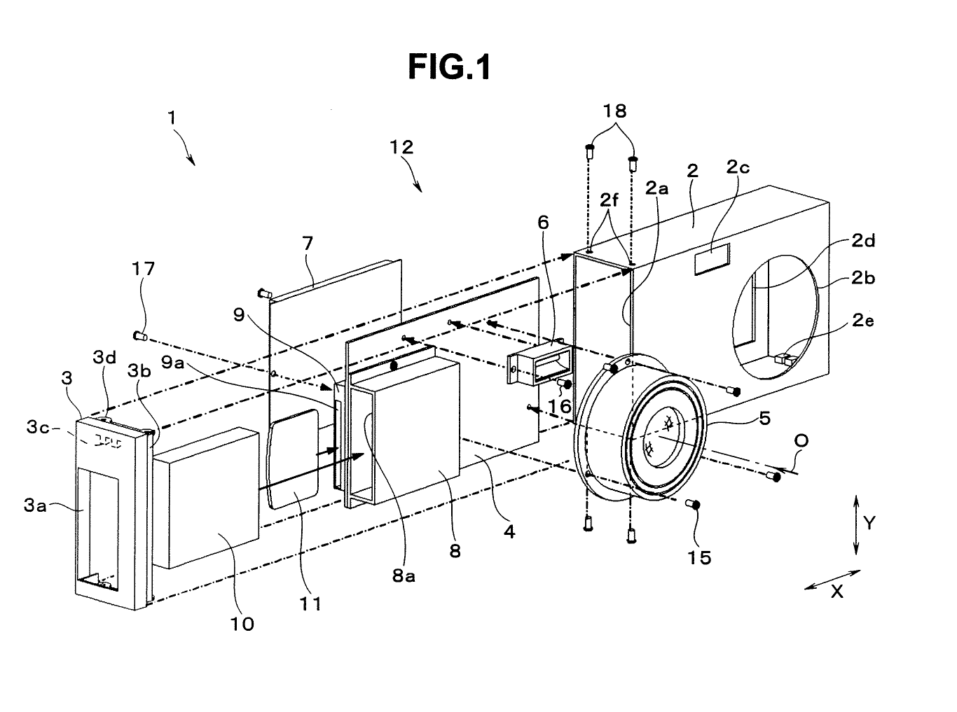

FIG. 1 is an exploded perspective view of a digital camera as an electronic photographing apparatus according to a first embodiment of the present invention.

As shown in FIG. 1, a digital camera 1 as an electronic photographing apparatus according to the present embodiment is configured such that a camera structure 12, to be described later, constituted of a main board to which a barrel unit as a lens barrel portion, a strobe unit, a display device, a battery case, a recording medium case and the like are attached, is housed in the exterior case 2 by inserting the camera structure 12 from a left side of an opening portion 2a of the exterior case. In the state where the camera structure is housed, an exterior case lid 3 is secured to the exterior case with the opening portion covered with the exterior case lid 3, and thereby the digital camera 1 is completed.

Note that an optical axis of a taking lens incorporated in the barrel unit 5 is shown by the reference sign “O” in the drawing, and among the directions perpendicular to the optical axis O, the left/right direction is defined as an X direction and the up/down direction is defined as a Y direction in the description below. The left/right direction is defined by the direction of the camera viewed from a subject side. The same also holds true for description of each embodiment other than the first embodiment.

More detailed description will be made on the configuration of the digital camera 1. The digital camera 1 includes the exterior case 2 as an exterior body, the exterior case lid 3, and furthermore, a camera structure 12 as a structure constituted of a main board 4 as an electric circuit board and an electronic photographing apparatus constituting unit to be described later.

Note that the electronic photographing apparatus constituting unit includes the barrel unit 5 as a lens unit which incorporates a taking lens, an image pickup unit (not shown) including an image pickup device, a strobe unit 6 including a strobe light-emitting portion, a display device unit 7 including an LCD, a battery case 8, and a recording medium case 9.

The exterior case 2 is an integrated box shaped member configured of a metal molded product, a drawing pressed product, or a high-rigid resin molded product. The exterior case 2 includes the opening portion 2a formed at an end portion in the X direction. In addition, the exterior case 2 includes at a front face portion thereof a taking lens opening portion 2b and a strobe window opening portion 2c, and includes at a rear face portion thereof a display device opening portion 2d. Furthermore, screw insertion holes 2f are formed on a top face and a bottom face of the exterior case 2 in the vicinity of the opening portion 2a. In addition, board supporting portions 2e are disposed at end portions of the inner sides of the top face and the bottom face in the vicinity of a face opposing to the opening portion 2a of the exterior case 2. In addition, a barrel accessory (not shown) is secured around the taking lens opening portion 2b, a strobe window portion (not shown) is secured to the strobe window opening portion 2c, and a display window (not shown) is secured to the display device opening portion 2d. Furthermore, operation buttons (not shown) are disposed on the top face portion and a rear face portion of the exterior case 2.

The exterior case lid 3 includes a fitting portion 3b to be fitted in the opening portion 2a of the exterior case 2 and an insertion opening portion 3a for inserting and extracting the battery 10 and the recording medium 11. In addition, board supporting portions 3c are disposed at upper and lower portions inside the fitting portion 3b, respectively.

The main board 4 is formed of an engineering plastic substrate which has high strength and is less subject to temperature changes, such as a glass-fiber containing epoxy resin substrate, and formed in a thickness having sufficient strength for supporting the electronic photographing apparatus constituting unit including the barrel unit 5 and the like.

Various electric control devices of the camera are mounted on the main board 4. Furthermore, the barrel unit 5, the strobe unit 6, the display device unit 7, the image pickup unit, furthermore, the battery case 8 and the recording medium case 9, which constitute the electronic photographing apparatus constituting unit, are secured on the both sides of the main board 4 with screws 15, 16, 17 and the like, thereby forming a camera structure 12.

Note that the barrel unit 5 and the strobe unit 6 are disposed on the front face of the main board 4 and the display device unit 7 is disposed on the rear face of the main board 4.

In addition, the battery case 8 is provided with a battery insertion opening portion 8a for inserting and extracting the battery 10 as a power supplying medium along the X direction. The recording medium case 9 is provided with a recording medium insertion opening portion 9a for inserting and extracting the recording medium 11 such as a memory card along the X direction. The battery insertion opening portion 8a and the recording medium insertion opening portion 9a are located on the left end of the main board 4 in the X direction.

The camera structure 12 constituted of the main board 4 to which the electronic photographing apparatus constituting unit is secured is inserted in the exterior case 2 from the opening portion 2a with a principal plane of the main board 4 held in parallel with an XY plane. Then, the upper and lower portions of the distal end portion of the main board 4 are fitted into the board supporting portions 2e, to thereby carry out the positioning of the main board 4 in the optical axis O direction. After the insertion of the camera structure, the fitting portion 3b of the exterior case lid 3 is fitted into the opening portion 2a of the exterior case 2 to be mounted thereto, and then the exterior case lid 3 is fixed to the exterior case 2 by inserting the screws 18 through the screw insertion holes 2f and driving the screws 18 in screw holes 3d on the exterior case lid 3. At that time, the main board 4 is fitted into the board supporting portions 3c of the exterior case lid 3, and pressed by the exterior case lid 3 in the X direction, to thereby carry out the positioning of the main board 4 with respect to the exterior case 2 in the XY directions and the optical axis O direction. Positioning of the barrel unit 5, the strobe unit 6, and the display device unit 7 of the camera structure 12 is carried out with these units opposed to the respective opening portions of the exterior case 2, thereby completing the assembly of the digital camera 1.

Note that, in the above-described assembled state, the battery 10 and the recording medium 11 can be inserted into and extracted from the insertion opening portion 3a of the exterior case lid 3 along the X direction.

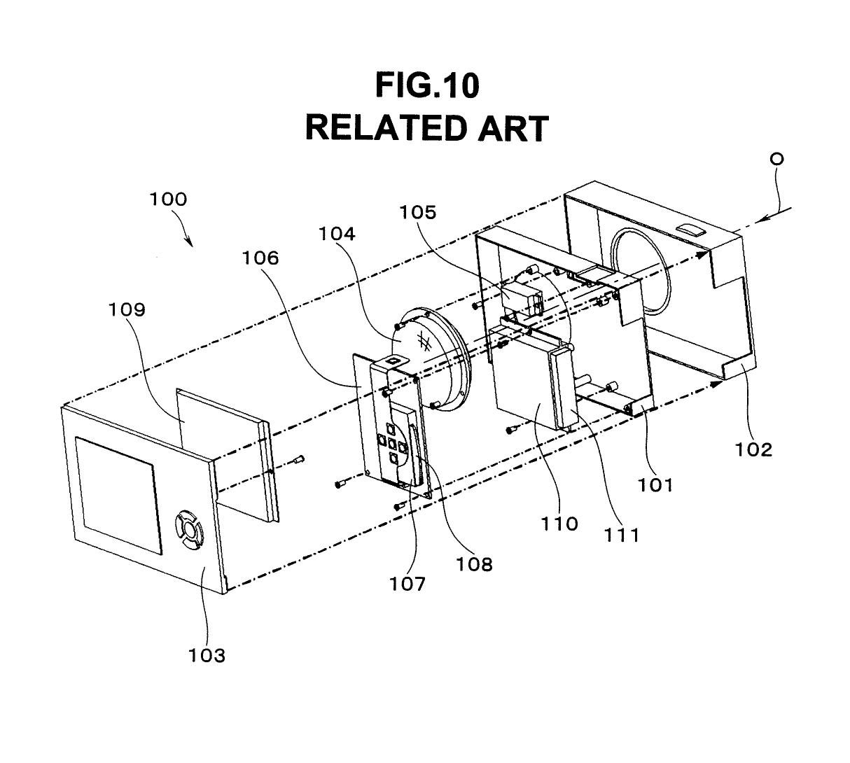

In the digital camera 1 having the above-described configuration, the camera structure 12 is configured such that the barrel unit 5, which particularly requires stable support against the external force and temperature changes among the electronic photographing apparatus constituting unit, is secured to and supported by the main board 4 formed of the substrate which has high strength and is stable against temperature changes, and furthermore, the camera structure 12 is inserted into the exterior case 2 which is formed in a box shape and hard to deform, to be fixed thereto. Accordingly, compared with the conventional camera described with reference to FIG. 10, the number of components of the digital camera according to the present embodiment can be reduced, because the camera main body is unnecessary. In addition, the electronic photographing apparatus constituting unit such as the barrel unit 5 is mechanically fixed firmly to the exterior case 2, thereby capable of providing a camera which is resistant to an external force and stable against temperature changes and which has a compact exterior shape. Furthermore, the configuration in which the box-shaped exterior case 2 is covered with the exterior case lid 3 is employed, thereby easily forming the hermetically-sealed structure of the camera and thus obtaining a water-proof structure of the camera.

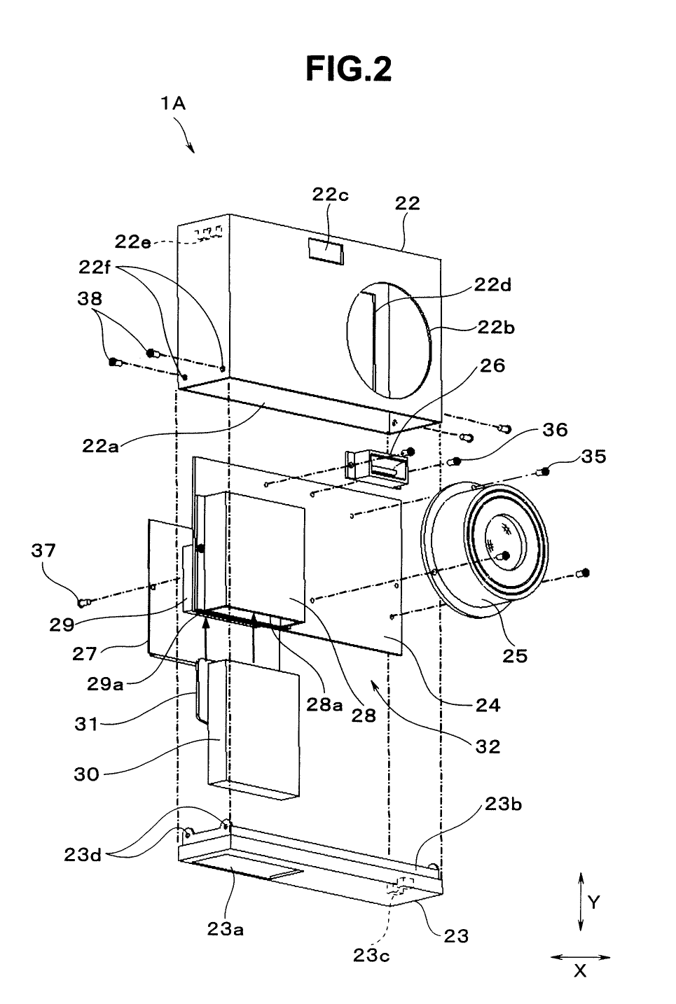

Next, a digital camera as an electronic photographing apparatus according to a second embodiment of the present invention is described with reference to FIG. 2 which is an exploded perspective view of the camera.

Similarly to the digital camera of the first embodiment, a digital camera 1A according to the present embodiment is configured such that a camera structure 32, to be described later, constituted of a main board to which a barrel unit (lens barrel portion), a strobe unit, a display device, a battery case, a recording medium case and the like are attached, is housed inside an exterior case 22. However, the present embodiment employs a structure in which the camera structure is housed by inserting the camera structure into the exterior case from an opening portion 22a located on the lower side of the exterior case, as shown in FIG. 2. Other configurations are the same as those in the first embodiment. Hereinafter, only different parts will be detailed in particular.

The digital camera 1A according to the present embodiment includes the exterior case 22 as an exterior body, an exterior case lid 23, and furthermore, a camera structure 32 as a structure constituted of a main board 24 as an electric circuit board and an electronic photographing apparatus constituting unit to be described later.

The electronic photographing apparatus constituting unit includes a barrel unit 25 as a lens unit which incorporates a taking lens, an image pickup unit (not shown) including an image pickup device, a strobe unit 26 including a strobe light-emitting portion, a display device unit 27 including an LCD, a battery case 28, and a recording medium case 29.

The exterior case 22 is an integrated box shaped member configured of a metal molded product, a drawing pressed product, or a high-rigid resin molded product. The exterior case 22 includes the opening portion 22a formed at a lower end portion in the Y direction. In addition, the exterior case 22 includes, at a front face portion thereof in the optical axis O direction, a taking lens opening portion 22b and a strobe window opening portion 22c, and at a rear face portion thereof in the optical axis O direction, a display device opening portion 22d. Furthermore, screw insertion holes 22f are formed on a left side face and right side face of the exterior case 22 in the vicinity of the opening portion 22a of the exterior case 22. In addition, board supporting portions 22e are disposed at end portions on the inner sides of the left side face and the right side face in the vicinity of a face opposing to the opening portion 22a of the exterior case 22. In addition, a barrel accessory (not shown) is secured around the taking lens opening portion 22b, a strobe window portion (not shown) is secured to the strobe window opening portion 22c, and a display window (not shown) is secured to the display device opening portion 22d. Furthermore, operation buttons (not shown) are disposed on a top face portion and a rear face portion of the exterior case 22.

The exterior case lid 23 includes a fitting portion 23b to be fitted in the opening portion 22a of the exterior case 22 and an insertion opening portion 23a for inserting and extracting a battery 30 and a recording medium 31. In addition, board supporting portions 23c are disposed on an inner face of the fitting portion 23b.

The main board 24 is formed of an engineering plastic substrate which has high strength and is less subject to temperature changes, such as a glass-fiber containing epoxy resin substrate, and formed in a thickness having sufficient strength for supporting the electronic photographing apparatus constituting unit including the barrel unit 25 and the like.

Various electric control devices of the camera are mounted on the main board 24. Furthermore, the barrel unit 25, the strobe unit 26, the display device unit 27, the image pickup unit, furthermore, the battery case 28 and the recording medium case 29, which constitute the electronic photographing apparatus constituting unit, are secured on the both sides of the main board 24 with screws 35, 36, 37, and the like, thereby forming the camera structure 32.

Note that the barrel unit 25 and the strobe unit 26 are disposed on the front face of the main board 24 and the display device unit 27 is disposed on the rear face of the main board 24.

In addition, the battery case 28 is provided with a battery insertion opening portion 28a for inserting and extracting the battery 30 as a power supplying medium along the Y direction. The recording medium case 29 is provided with a recording medium insertion opening portion 29a for inserting and extracting the recording medium 31 such as a memory card along the Y direction. The battery insertion opening portion 28a and the recording medium insertion opening portion 29a are located on the lower end of the main board 24 in the Y direction.

The camera structure 32 constituted of the main board 24 to which the electronic photographing apparatus constituting unit is secured is inserted in the exterior case 22 from the opening portion 22a with a principal plane of the main board 24 held in parallel with the XY plane. Then, the distal end portion of the main board 24 is fitted into the board supporting portions 22e, to thereby carry out the positioning of the main board 24 in the optical axis O direction. The fitting portion 23b of the exterior case lid 23 is fitted into the opening portion 22a of the exterior case 22 to mount the exterior case lid 23 to the exterior case 22, and then the exterior case lid 23 is fixed to the exterior case 22 by inserting screws 38 through the screw insertion holes 22f and driving the screws 38 into screw holes 23d on the exterior case lid 23. In this state, the main board 24 is fitted in the board supporting portions 23c, and pressed by the exterior case lid 23 in the Y direction, to be fixed with respect to the exterior case 22 in the XY directions and the optical axis O direction. In the state that the exterior case lid is mounted, positioning of the barrel unit 25, the strobe unit 26, and the display device unit 27 of the camera structure 32 is carried out, with these units opposed to the respective opening portions of the exterior case 22, and thereby the assembly of the digital camera 1A is completed.

Note that, in the above-described assembled state, the battery 30 and the recording medium 31 can be inserted into and extracted from the insertion opening portion 23a of the exterior case lid 23 along the Y direction.

According to the digital camera 1A having the above-described configuration, the same effects as those of the digital camera 1 according to the first embodiment can be exhibited, and it is possible to provide an camera which has reduced number of components and which is resistant to an external force and stable against temperature changes by mechanically firmly fixing the electronic photographing apparatus constituting unit such as the barrel unit 25 to the exterior case 22. As a result, it is possible to obtain stable photographic images. At the same time, the exterior shape of the camera can be formed in a compact size. Furthermore, the camera has the configuration in which the box-shaped exterior case 22 is covered with the exterior case lid 23, thereby easily forming the hermetically-sealed structure of the camera. and thus obtaining a water-proof structure of the camera.

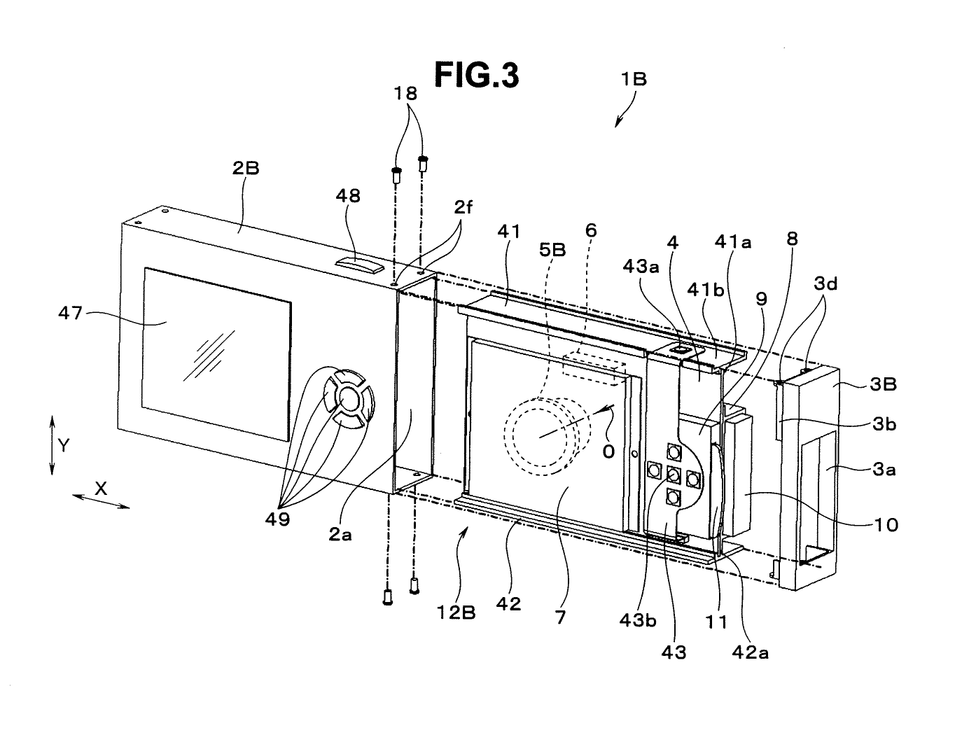

Next, a digital camera as an electronic photographing apparatus according to a third embodiment of the present invention is described with reference to FIGS. 3 to 6.

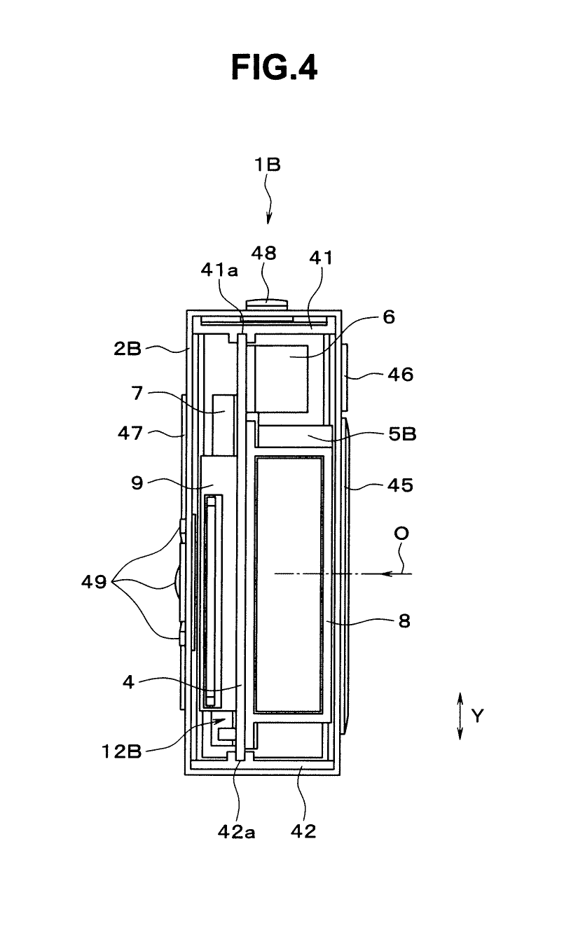

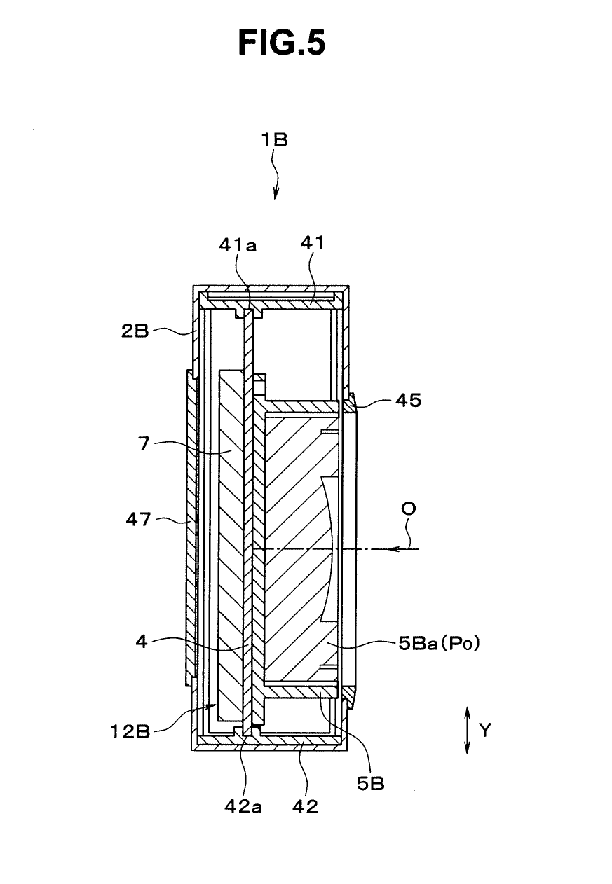

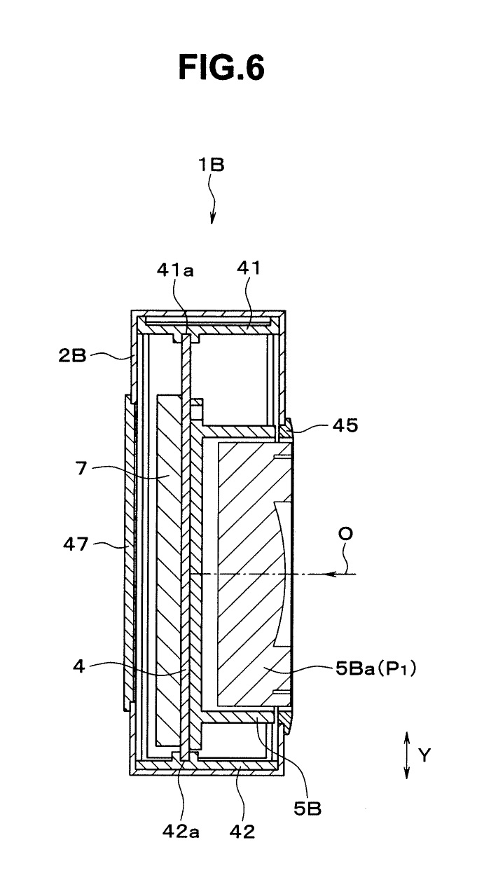

FIG. 3 is an exploded perspective view of a digital camera according to the present embodiment. FIG. 4 is a vertical cross-sectional view of the digital camera. FIG. 5 is a vertical cross-sectional view along the optical axis O illustrating the digital camera in a state where the camera structure is inserted in an exterior case. FIG. 6 is a vertical cross-sectional view along the optical axis O illustrating the digital camera in a state where the lens barrel is set in a collapsed position after the camera structure is inserted into the exterior case.

Similarly to the digital camera 1 according to the first embodiment, a digital camera 1B according to the present embodiment is configured such that a camera structure 12B constituted of a main board to which a barrel unit (lens barrel), a strobe unit, a display device, a battery case, a recording medium case, and the like are attached, is housed inside an exterior case 2B. As shown in FIG. 3, the present embodiment is different from the first embodiment in that structure supporting members are provided at the upper and lower end portions of the main board as supporting members for positioning of the camera structure in the exterior case, the barrel unit can be switched among a retracted state (in which the camera structure can be inserted into the exterior case), a collapsed state (non-photographing state), and a photographing enable state, and an operation switch FPC (Flexible Printed Circuit) on which a group of camera operation switches is provided is mounted as the camera structure. Other configurations are the same as those in the first embodiment. The same components are attached with the same reference signs and hereinafter, different configuration parts will be described in particular.

The digital camera 1B according to the present embodiment includes an exterior case 2B as an exterior body, and an exterior case lid 3B, and furthermore, a camera structure 12B as a structure constituted of the main board 4 as an electric circuit board and the electronic photographing apparatus constituting unit to be described later.

The electronic photographing apparatus constituting unit includes a barrel unit 5B which incorporates a taking lens, an image pickup unit (not shown) including an image pickup device, a strobe unit 6 including a strobe light-emitting portion, a display device unit 7 including an LCD, a battery case 8, a recording medium case 9, and an operation switch FPC 43 on which a group of operation switches 43b and a release switch 43a are mounted.

The barrel unit 5B incorporates a lens barrel 5Ba which can advance and retract with regard to the exterior case 2B, and enables the lens barrel 5Ba to move among a retracted position P0, a collapsed position P1, and an extended position at which photographing is possible (FIGS. 5, 6). The retracted position P0 is a position at which the lens barrel 5Ba is retracted most, and is a position for allowing the lens barrel 5B to be inserted into the exterior case 2B (FIG. 5). The collapsed position P1 is a position at which the lens barrel is slightly extended more than at the retracted position P0, and is a position at which the digital camera is switched to the non-photographing state by turning off the power switch, for example (FIG. 6). The extended position at which photographing is possible is a position at which the lens barrel is extended from the collapsed position P1 to perform photographing.

Before inserting the camera structure 12B constituted of the main board 4 and the electronic photographing apparatus constituting unit into the exterior case 2B, an upper structure supporting member 41 and a lower structure supporting member 42 are attached on an upper end portion and a lower end portion of the main board 4, respectively. The camera structure 12B in the above-described attached state is inserted into the exterior case 2B.

More particularly, the upper and lower structure supporting members 41 and 42 are provided with supporting grooves 41a and 42a formed along the X direction into which the main board 4 can be fitted. The upper and lower end portions of the main board 4 to which the electronic photographing apparatus constituting unit is secured are fitted into the supporting grooves 41a and 42a. Furthermore, the operation switch FPC 43 connected to the main board 4 through a connector is guided to a recess portion 41b of the upper structure supporting member 41 via a rear face of the recording medium case 9, and the operation switch 43b and the release switch 43a are fixed on the rear face of the recording medium case 9 and on the recess portion 41b, respectively.

The camera structure 12B constituted of the main board 4 to which the electronic photographing apparatus constituting unit including the operation switch FPC 43 is secured and the upper and lower structure supporting members 41, 42 are attached is slidingly inserted into the exterior case 2B from the opening portion 2a formed at end portion in the X direction. FIG. 4 is a vertical cross-sectional view of the digital camera after the camera structure is inserted into the exterior case.

Note that the widths in the optical axis O direction of the upper and lower structure supporting members 41, 42 are set, with respect to the inner width in the optical axis O direction of the exterior case 2B, in a dimension for allowing the upper and lower structure supporting members 41, 42 to be fitted in the exterior case 2B without clearance. In this case, the upper and the lower structure supporting members 41, 42 may be slightly pressed into the exterior case 2B in the optical axis O direction. Similarly, the dimension between the end faces in the Y direction of the upper and lower structure supporting members 41, 42 which are attached to the main board 4 is set, with respect to the inner width in the height direction of the exterior case 2B, in a dimension for allowing the upper and lower structure supporting members 41, 42 to be fitted in the exterior case 2B without clearance. In this case, the upper and lower structure supporting members 41, 42 may be slightly pressed into the exterior case 2B in the height direction. In the exterior case 2B, there is no need for providing the board supporting portions 2e which are provided in the first embodiment. Similarly, in the exterior case lid 3B, there is no need for providing the board supporting portions 3c.

After the insertion of the camera structure into the exterior case, the exterior case lid 3B is fitted in the opening portion 2a of the exterior case 2B, to be fixed to the exterior case 2B by inserting the screws 18 through the screw insertion holes 2f and driving the screws 18 in the screw holes 3d of the exterior case lid 3B. In this fixed state, the main board 4 is pressed by the exterior case lid 3B in the X direction and supported without clearance also in the optical axis O direction and the Y direction.

Note that a barrel accessory 45 is attached to a front face portion of the lens opening portion of the exterior case 2B. A strobe window member 46 is attached to a front face portion of the strobe opening portion. A display device protection panel 47 is attached to a front face portion of a display device unit opening portion. Furthermore, a release button 48 and a group of operation switch buttons 49 as electronic photographing apparatus operation members are disposed previously at an upper position opposed to the release switch 43a and at a rear face position opposed to the group of operation switches 43b, respectively.

When the camera structure 12B is inserted into the exterior case 2B as described above, the barrel unit 5B is set in the state where the lens barrel 5Ba is retracted to the above-described retracted position P0 so that the barrel unit 5B does not interfere with the exterior case 2B. After the insertion of the camera structure, the lens barrel 5Ba is driven to be extended to the above-described collapsed position P1. This state is the power switch-off state or the non-photographing state in the digital camera 1B.

The above-described digital camera 1B according to the present embodiment exhibits the same effects as those of the digital camera 1 according to the first embodiment. Furthermore, the upper and lower structure supporting members 41, 42 are provided for positioning of the camera structure 12B at the time that the camera structure 12B is inserted into the exterior case 2B, thereby facilitating the incorporation of the camera structure 12B into the box-shaped exterior case 2B.

Furthermore, the camera structure is inserted into the exterior case 2B with the lens barrel 5Ba of the barrel unit 5B retracted to the retracted position P0 at which the lens barrel is more retracted than at the collapsed position P1 as the non-photographing state, and after the insertion, the lens barrel 5Ba is extended to the collapsed position P1 as the non-photographing state, thereby enabling the lens barrel unit 5B to be incorporated into the exterior case 2B in a preferred manner.

In the above-described third embodiment, the lens barrel 5Ba of a type extendable outward is used as the barrel unit 5B. However, a modified example can be proposed, in which, instead of the above-described type of barrel unit, a barrel unit including a photographing optical system which is a bending optical system as a taking lens optical system, and configured such that the lens barrel is not projected and extended outward from the front face of the barrel unit to the subject side is used.

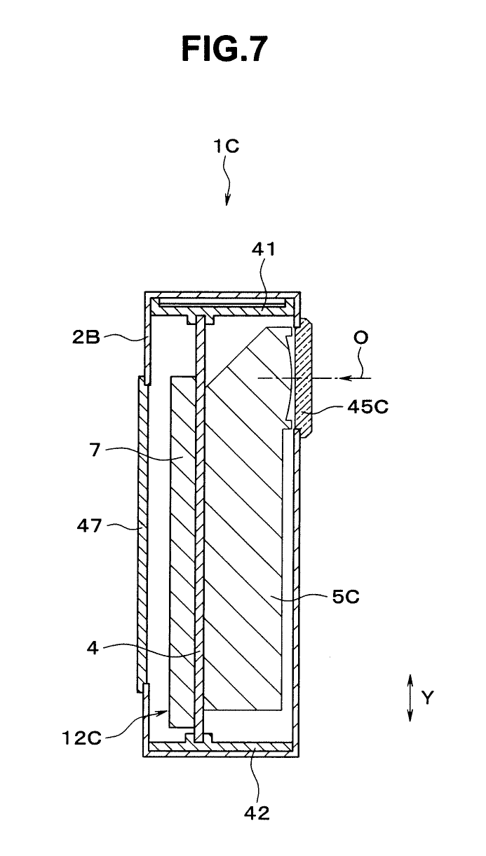

As shown in the vertical cross-sectional view in FIG. 7, a digital camera 1C according to the present modified example is different from the digital camera 1B according to the third embodiment only in the configurations and arrangements of the barrel unit and barrel accessory. Other than these, the digital camera 1C has the same configurations as those in the digital camera 1B. Therefore, the same components are attached with the same reference signs and only different points are described below.

A barrel unit 5C of a camera structure 12C applied to the digital camera 1C according to the present modified example incorporates a photographing optical system which uses the above-described bending optical system for bending an optical axis and the barrel unit is attached to the front face portion of the main board 4. A photographing window member 45C is secured to the front face of the exterior case 2B at a position on the optical axis O of the barrel unit 5C. The lens barrel is not projected forward from the barrel unit 5C. Accordingly, a rear face of the photographing window member 45C is substantially in plane with the inner face of the exterior case 2B, thereby enabling the barrel unit 5C to be inserted into the exterior case 2B.

As described above, according to the present modified example, the same housing structure as that in the third embodiment is employed also in the digital camera which incorporates the photographing optical system using the bending optical system, thereby easily forming the hermetically-sealed structure of the camera and thus obtaining the water-proof structure of the camera.

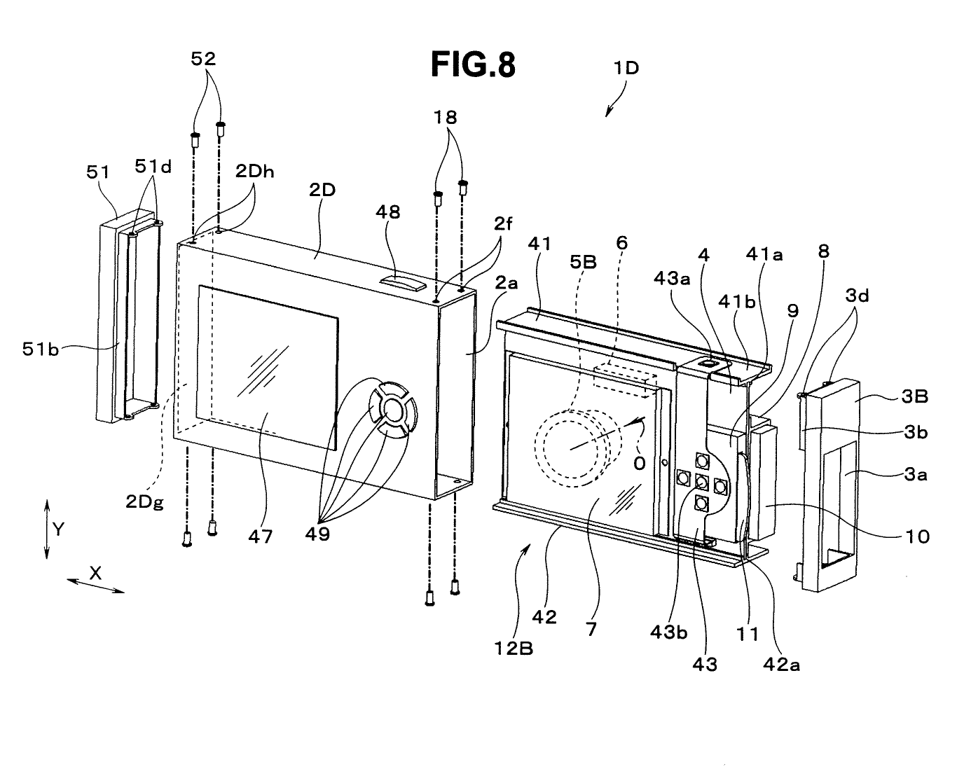

Next, a digital camera as an electronic photographing apparatus according to a fourth embodiment of the present invention will be described with reference to FIG. 8 which is an exploded perspective view of the camera.

A digital camera 1D according to the present embodiment is different from the digital camera 1B according to the third embodiment in that opening portions are provided on both ends in the X direction of the exterior case in the housing structure and a pair of exterior case lids that close the opening portions are provided. Other configurations are the same as those in the third embodiment. The same components are attached with the same reference signs and only the different points are described below.

An exterior case 2D of the digital camera 1D according to the present embodiment is provided with opening portions 2a, 2Dg on the both end portions in the X direction, as described above. In addition, an exterior case lid 3B to be fitted to the one opening portion 2a and an exterior case lid 51 to be fitted to the other opening portion 2Dg are provided.

Similarly to the case in the third embodiment, the camera structure 12B to which the upper and lower structure supporting members 41, 42 are attached is inserted into the exterior case 2D from an end portion in the X direction. After the insertion, the exterior case lid 3B and the exterior case lid 51 are fixed to the opening portions 2a, 2Dg of the exterior case 2D, respectively, by fitting the fitting portions 3b, 51b into the opening portions 2a, 2Dg, and inserting the screws 18, 52 through exterior case screw insertion holes 2f, 2Dh and driving the screws into exterior case lid screw holes 3d, 51d. In the fixed state, the opening portions 2a, 2Dg of the exterior case 2D are both covered and at the same time, the main board 4 is fixed and supported in the XY directions and the optical axis O direction in the exterior case 2D.

Also the digital camera 1D according to the present embodiment exhibits the same effects as those of the digital camera 1B according to the third embodiment. Furthermore, the both end portions of the exterior case 2D are open, so that adjustment operation inside the case is easy at the time of assembly.

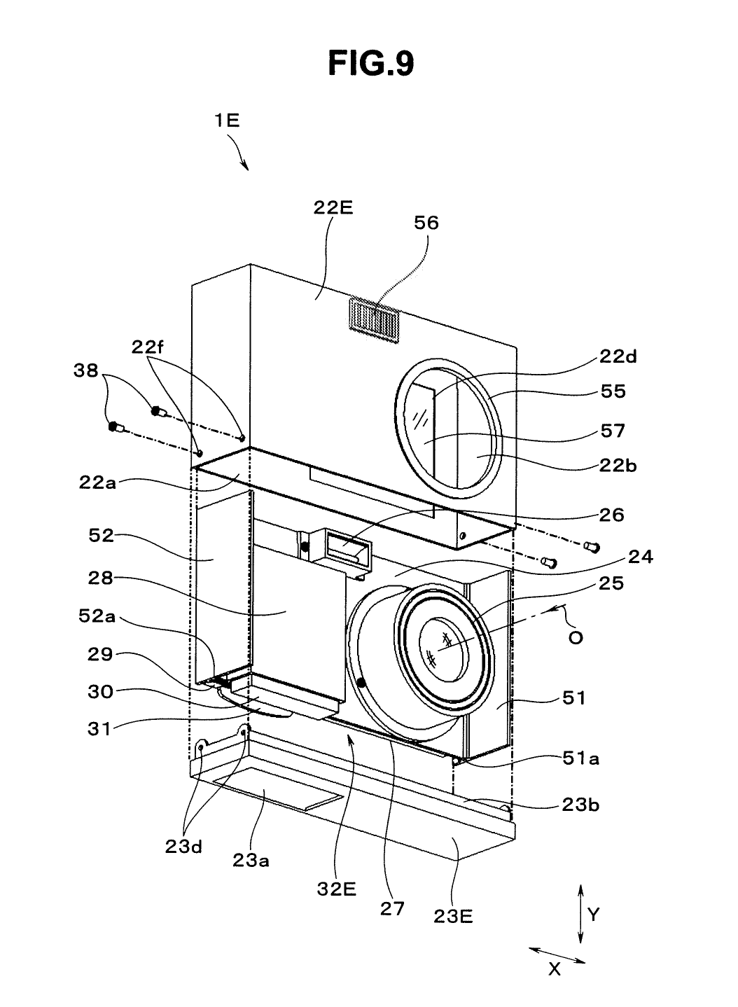

Next, a digital camera as an electronic photographing apparatus according to a fifth embodiment of the present invention is described with reference to FIG. 9 which is an exploded perspective view of the camera.

A digital camera 1E of the present embodiment is different from the digital camera 1A according to the second embodiment in that structure supporting members are attached to the main board in the housing structure. Other configurations are the same as those in the second embodiment. The same components are attached with the same reference signs and only the different points are described below.

As shown in FIG. 9, in a camera structure 32E of the digital camera 1E according to the present embodiment, a right structure supporting member 51 and a left structure supporting member 52 are attached to both end portions in the X direction of the main board 24 to which the electronic photographing apparatus constituting unit such as the barrel unit is secured.

The right and left structure supporting members 51, 52 are provided with supporting grooves 51a, 52a formed along the Y direction into which the main board 24 can be fitted. The right and left end portions of the main board 24 to which the electronic photographing apparatus constituting unit is secured are fitted into the supporting grooves 51a, 52a, thereby attaching the right and left structure supporting members 51, 52 to the main board.

The camera structure 32E in the state where the right and left structure supporting members 51, 52 are attached to the main board 24 is slid upward to be inserted into the exterior case 22E from the opening portion 22a of the exterior case 22E.

Note that the widths in the optical axis O direction of the right and left structure supporting members 51, 52 are set, with respect to the inner width in the optical axis O direction of the exterior case 22E, in a dimension for allowing the right and left structure supporting members 51, 52 to be fitted in the exterior case 22E without clearance. In this case, the right and left structure supporting members 51, 52 may be slightly pressed into the exterior case 22E in the optical axis direction. Similarly, the dimension between the end faces in the X direction of the right and left structure supporting members 51, 52 which are attached to the main board 24 is set, with respect to the inner width in the X direction of the exterior case 22E, in a dimension for allowing the right and left structure supporting members 51, 52 to be fitted in the exterior case 22E without clearance. In this case, the right and left structure supporting members 51, 52 may be slightly pressed into the exterior case 22E in the X direction. In the exterior case 22E, there is no need for providing the board supporting portions 22e which are provided in the second embodiment. Similarly, in the exterior case lid 23E, there is no need for providing the board supporting portions 23c.

After the insertion of the camera structure, the exterior case lid 23E is fitted into the opening portion 22a of the exterior case 22E to be fixed thereto by inserting the screws 38 through the screw insertion holes 22f and driving the screws into the screw holes 23d of the exterior case lid 23E. In this fixed state, the main board 24 is pressed by the exterior case lid 23E in the Y direction and supported without clearance in the optical axis O direction and the Y direction.

The above-described digital camera 1E according to the present embodiment exhibits the same effects as those of the digital camera 1A according to the second embodiment. Furthermore, the right and left structure supporting members 51, 52 are provided for positioning of the camera structure 32E at the time that the camera structure 32E is inserted into the exterior case 22E, thereby facilitating the incorporation of the camera structure 32E into the box-shaped exterior case 22E.

The present invention is not limited to each of the embodiments, and the upper and lower structure supporting members may be configured as an integrated member and the right and left structure supporting members may be configured as an integrated member in each of the embodiments, and various modifications can be made without departing from the gist of the present invention in implementation of the present invention. Furthermore, the above-described embodiments include inventions of various stages, and by combining a plurality of constituent components disclosed in the embodiments, inventions of various stages can also be extracted.

In the present invention, it is apparent that various embodiments can be made in a broad sense based on the present invention without departing from the spirit and scope of the present invention. The present invention is not limited by a specific embodiment except as by the appended claims.

What is claimed is:

1. An electronic photographing apparatus comprising:
a structure including an electric circuit board and an electronic photographing apparatus constituting unit attached to the electric circuit board; and
a box-shaped exterior body configured to house the structure.

2. An electronic photographing apparatus comprising:
a structure including an electric circuit board and an electronic photographing apparatus constituting unit attached to each face of the electric circuit board so as to sandwich the electric circuit board; and
a box-shaped exterior body configured to house the structure.

3. The electronic photographing apparatus according to claim 1, wherein the box-shaped exterior body includes an opening for inserting the structure opened in a direction in which a recording medium or a power supplying medium is inserted and extracted.

4. The electronic photographing apparatus according to claim 2, wherein the box-shaped exterior body includes an opening for inserting the structure opened in a direction in which a recording medium or a power supplying medium is inserted and extracted.

5. The electronic photographing apparatus according to claim 3, wherein the box-shaped exterior body includes a lid member configured to close the opening.

6. The electronic photographing apparatus according to claim 4, wherein the box-shaped exterior body includes a lid member configured to close the opening.

7. The electronic photographing apparatus according to claim 1, wherein the box-shaped exterior body includes an electronic photographing apparatus operation member previously secured thereto.

8. The electronic photographing apparatus according to claim 2, wherein the box-shaped exterior body includes an electronic photographing apparatus operation member previously secured thereto.

9. The electronic photographing apparatus according to claim 3, wherein the box-shaped exterior body includes an electronic photographing apparatus operation member previously secured thereto.

10. The electronic photographing apparatus according to claim 4, wherein the box-shaped exterior body includes an electronic photographing apparatus operation member previously secured thereto.

11. The electronic photographing apparatus according to claim 5, wherein the box-shaped exterior body includes an electronic photographing apparatus operation member previously secured thereto.

12. The electronic photographing apparatus according to claim 6, wherein the box-shaped exterior body includes an electronic photographing apparatus operation member previously secured thereto.

13. An electronic photographing apparatus comprising a structure including an electric circuit board and an electronic photographing apparatus constituting unit attached to the electric circuit board so as to sandwich the electric circuit board, and a box-shaped exterior body configured to house the structure,
wherein:
the box-shaped exterior body includes an opening for inserting the structure opened in a direction in which a recording medium or a power supplying medium is inserted and extracted;
the opening is closed by a lid member;
the structure is supported by the exterior body through a structure supporting member; and
the exterior body includes an electronic photographing apparatus operation member previously secured thereto.

14. An electronic photographing apparatus comprising:
a structure including an electric circuit board, a lens unit fixed to the electric circuit board, and an electronic photographing apparatus constituting unit attached to the electric circuit board so as to sandwich the electric circuit board;
and a box-shaped exterior body configured to house the structure,
wherein the lens unit is displaced to a state among a photographing enable state, a collapsed state in a non-photographing state, and a retracted state where the lens unit can be inserted into the exterior body.

15. An electronic photographing apparatus comprising a structure including an electric circuit board and an electronic photographing apparatus constituting unit attached to the electric circuit board so as to sandwich the electric circuit board and an exterior body configured to house the structure, wherein
the exterior body includes two openings for inserting the structure including the electronic photographing apparatus constituting unit, the openings being disposed at one end face where a recording medium or a power supplying medium is inserted and extracted and at other end face opposed to the one end face, respectively, and
the exterior body further includes lid members for closing the both openings of the exterior body.
